(19) United States
(12) Patent Application Publication
(10) Pub. No.: US 2024/0098853 A1
(43) Pub. Date: Mar. 21, 2024

(54) HOUSEHOLD APPLIANCE SYSTEM

(71) Applicant: BSH Hausgeräte GmbH, Munich (DE)

(72) Inventors: Tomas Cabeza Gozalo, Zaragoza (ES); Javier Lasobras Bernad, EJEA DE LOS CABALLEROS (ZARAGOZA) (ES); Sergio Llorente Gil, Zaragoza (ES); Emilio Plumed Velilla, Zaragoza (ES); Julio Rivera Peman, Cuarte de Huerva (Zaragoza) (ES); Javier Serrano Trullen, Zaragoza (ES)

(21) Appl. No.: 17/768,873

(22) PCT Filed: Nov. 10, 2020
(86) PCT No.: PCT/EP2020/081622

§ 371 Date: Apr. 14, 2022

(30) Foreign Application Priority Data
Nov. 27, 2019 (EP) 19383053.6

(51) Int. Cl. H05B 6/12; H05B 6/06

(52) U.S. Cl. CPC H05B 6/1236; H05B 6/062

(57) ABSTRACT

A household appliance system includes a household appliance having a first induction unit configured to inductively supply energy, a household unit having a second induction unit configured to inductively receive the energy that is supplied from the first induction unit, and a safety unit configured to prevent, as a function of a safety parameter, at least in an interval a transmission of energy to the second induction unit.

The invention relates to a household appliance system according to the preamble of claim 1 and to a method for operating a household appliance system according to the preamble of claim 15.

The prior art already discloses a household appliance system that has a household appliance and a household unit. The household appliance is designed as an induction hob and has a first induction unit, which in one operating state inductively supplies energy, and in fact to the household unit. The household unit has a second induction unit, which in one operating state inductively receives the energy that is inductively supplied. In one operating state, the first induction unit transmits the energy if the household unit and consequently the second induction unit are positioned in close proximity to the first induction unit, and in fact independently of any safety parameters.

The object of the invention is in particular, but not limited thereto, to provide a generic system having improved characteristics with respect to safety. The object is achieved in accordance with the invention by the features of claims 1 and 15, whereas advantageous embodiments and developments of the invention can be taken from the dependent claims.

The invention is based on a household appliance system, in particular on an induction household appliance system, advantageously on a cooking system, particularly advantageously on an induction cooking system, preferably on a hob-type cooking system and particularly preferably on an induction hob-type cooking system, having at least one household appliance, which has at least a first induction unit that is provided so as to inductively supply energy, and having at least one household unit, which has at least a second induction unit that is provided so as to inductively receive the energy that is supplied.

It is proposed that the household appliance system has at least one safety unit, which is provided as a function of at least one safety parameter to prevent at least in intervals a transmission of energy in particular from the first induction unit to the second induction unit.

An embodiment of this type renders it possible in particular to realize a high degree of safety and in fact in particular both for a user and also for components of the household appliance system. It is particularly advantageously possible to purposefully avoid damage, for example to the household appliance and/or to the household unit, which could be caused for example by unintended and/or uncontrolled and/or incorrect transmission of energy, and by avoiding such transmissions it is possible in particular to guarantee a long-lasting embodiment. It is possible in particular to comply with current standards and/or specifications relating to a safety standard in the case of inductive transmission of energy and advantageously surpass to a great extent said standards and specifications, whereby in particular it is rendered possible to realize a particularly safe embodiment and/or a high degree of user comfort for a user.

The term a ‘household appliance system’ is to be understood to mean in particular a system, which has at least one household appliance object and/or at least the household appliance and/or at least the household unit and/or at least one household appliance accessory object, and which, in particular, can have in addition at least one kitchen object and/or at least one further component that could be designed in particular differently from a household appliance object and/or from a household appliance and/or from a household unit and/or from a household appliance accessory object. The term a ‘household appliance object’ is to be understood to mean in particular at least one part, in particular a sub-assembly, of a household appliance, in particular of a hob and advantageously of an induction cooking appliance. The term ‘household appliance accessory object’ is to be understood to mean in particular an object, which is provided in particular for usage and/or utilization with a household appliance and/or which is designed in particular as at least one accessory and/or as at least one set of accessories for a household appliance. The term a ‘kitchen object’ is to be understood to mean in particular an object, which is provided for usage and/or utilization and/or for arranging in a kitchen and in fact in particular for preparing and/or handling and/or storing at least one item of food.

The term a ‘household appliance’ is to be understood to mean in particular an electrical appliance, which has in particular at least one household appliance control unit for controlling and/or regulating at least one household appliance function and/or at least one household appliance main function. The household appliance is particularly advantageously a white goods appliance, which is provided in particular so as to perform a household task, such as for example cleaning, for example dishware and/or laundry and/or a room and/or a piece of furniture, and/or for cooking food and/or for cooling food.

For example, the household appliance could have at least one refrigeration appliance and could be advantageously designed as a refrigeration appliance. The household appliance could have for example at least one chest freezer and/or at least one chest fridge and/or at least one upright fridge and/or at least one upright freezer and/or at least one combination appliance. For example as an alternative or in addition thereto, the household appliance could have at least one cleaning appliance, such as for example at least one dryer and/or at least one washing machine and/or at least one dishwasher. The household appliance could, for example as an alternative or in addition thereto, have in particular at least one cooking appliance and advantageously at least one induction cooking appliance and/or said household appliance could be designed as such. For example, the household appliance could have at least one oven and/or at least one microwave and/or at least one grill appliance and/or at least one steam cooking appliance and/or said household appliance could be designed as such. The oven could be for example a cooker and/or a baking oven. Advantageously, the household appliance could have, in particular as an alternative or in addition thereto, in particular at least one hob and advantageously at least one induction hob and/or said household appliance could be designed as such.

In particular, the household appliance has the household appliance control unit, which is designed in particular as a control unit that is integrated at least in part and advantageously at least to a large extent in the household appliance. For example, the household unit could have at least one household unit control unit, which could be designed in particular as a control unit that is integrated at least in part and advantageously at least to a large extent in the household unit. The term a ‘control unit’ is to be understood to mean in particular an electrical and/or electronic unit, which in one operating state controls and/or regulates at least one appliance function and/or at least one appliance main function. The control unit has advantageously at least one computer unit and advantageously in addition to the computer unit at least one memory unit which advantageously stores at least one control and/or regulating program that is advantageously provided for execution by the computer unit.

The term an ‘induction unit’ is to be understood to mean in particular a unit, which in one operating state supplies and/or receives energy for the purpose of inductive transmission of energy. The induction unit has in particular at least one inductance. For example, the induction unit could have at least one coil and/or for example an arbitrary arrangement and/or circuit of coils, which could in particular define the inductance.

In particular in the case of the first induction unit, which could be provided so as to supply inductive energy, the first induction unit could have in one operating state, in particular for the purpose of an inductive transmission of energy, in particular at least one coil, in particular at least one primary coil, which could be provided in particular so as to inductively transmit energy to at least one coil, in particular to at least one secondary coil, of the second induction unit that is provided so as to receive induction energy. In particular, in one operating state the second induction unit receives energy for the purpose of inductively transmitting energy and in fact in particular by the first induction unit.

The first induction unit could have for example at least one heating unit, which could be designed in particular as an induction heating unit. In particular, the coil of the first induction unit could be designed as a heating unit and advantageously as an induction heating unit. In particular, the first induction unit in one operating state could provide an alternating field, in particular an electromagnetic alternating field, having a frequency of at least 1 kHz, in particular of at least 2 kHz, advantageously of at least 5 kHz and preferably of at least 10 kHz. In particular, the first induction unit in one operating mode could provide in particular an alternating field, in particular an electromagnetic alternating field, having a frequency of a maximum 150 kHz, in particular of a maximum 120 kHz, advantageously of a maximum 100 kHz and preferably of a maximum 80 kHz. The first induction unit in one operating state could provide in particular a high-frequency alternating field, in particular high frequency electromagnetic alternating field, having a frequency of at least 15 kHz and in particular of a maximum 100 kHz.

For example, the first induction unit could have precisely one coil. The first induction unit could have for example at least two, in particular at least three, advantageously at least four, particularly advantageously at least five, preferably at least eight and particularly preferably multiple coils, which in particular in one operating state could each inductively supply energy, and in fact in particular to the, in particular single, second induction unit and/or to at least two second induction units which could be integrated for example in different household units. For example, coils of the first induction unit could be designed in particular in each case as a heating unit and advantageously as an induction heating unit.

The term a ‘household unit’ is to be understood to mean in particular a unit, which could be provided so as to be used jointly and/or utilized jointly together with the household appliance and/or which could be designed for its part as a household appliance, and in fact advantageously as a small household appliance. For example, the household unit could be designed as at least one accessory for the household appliance and/or is at least one set of accessories for the household appliance. In particular as an alternative or in addition thereto, the household unit could be designed as an independent household appliance. In particular in the case of a household unit that is designed as a stand-alone household appliance, the household unit has in particular at least one household appliance control unit, which is provided in particular so as to control and/or regulate at least one household appliance function and/or at least one household appliance main function of the household unit.

The term a ‘safety unit’ is to be understood in particular to mean a unit, which in one operating state, as a function of the safety parameter impedes and/or prevents and/or blocks the inductive transmission of energy and in particular by preventing the inductive transmission of energy avoids and/or impedes an overcurrent in the second induction unit and/or an uncontrolled transmission of energy to the second induction unit and/or an incorrectly performed transmission of energy to the second induction unit.

For example the safety unit could be a mechanical unit. Advantageously the safety unit is an electrical and/or electronic unit. The safety unit has in particular at least one safety control unit, which is designed in particular as a control unit that is integrated at least in part and advantageously at least to a large extent in the safety unit.

The term a ‘safety parameter’ is to be understood to mean in particular a parameter, which characterizes and/or defines a degree of safety of an inductive transmission of energy to the second induction unit and, as a function of said parameter, the safety unit makes a decision regarding impeding the inductive transmission of energy to the second induction unit and/or regarding enabling the inductive transmission of energy to the second induction unit. Advantageously, the safety parameter is an electrical and/or electronic parameter and/or an electrical and/or electronic signal.

The phrase ‘that the safety unit is provided so as, as a function of at least one safety parameter, to prevent “at least in intervals” a transmission of energy to the second induction unit’ is to be understood in particular to mean that the safety unit in one operating state, as a function of the safety parameter, prevents the transmission of energy to the second induction unit at least in one time interval and for example in at least one further time interval, which could be spaced chronologically with respect to the time interval enables said transmission. For example, the safety unit in one operating state, as a function of the safety parameter, could from time to time prevent the transmission of energy to the second induction unit. In particular as an alternative or in addition thereto, the safety unit in one operating state, as a function of the safety parameter, could completely prevent the transmission of energy to the second induction unit.

The term ‘provided’ is to be understood to mean in particular specially programmed, designed and/or configured. This is also to be understood to mean that an object is provided for a specific function, in particular that the object fulfills and/or performs this specific function in at least one utilization state and/or operating state.

Moreover it is proposed that the safety unit has at least one safety element and is provided so as by means of the safety element to change at least one coupling parameter of a coupling of the first induction unit and the second induction unit so as to prevent the transmission of energy. In particular, the safety unit in one operating state changes by means of the safety element at least one coupling variable of a coupling of the first induction unit and the second induction unit so as to prevent the transmission of energy. The term a ‘coupling parameter’ is to be understood to mean in particular a parameter which characterizes and/or defines a coupling between the first induction unit and the second induction unit and which the safety unit changes so as to prevent the inductive transmission of energy to the second induction unit. For example, the coupling parameter could be a mechanical parameter, such as for example a spacing and/or a distance between the first induction unit and the second induction unit. For example as an alternative or in addition thereto, the coupling parameter could be an electrical and/or electronic parameter and/or an electrical and/or electronic signal. In the case of a change to the coupling parameter, the safety unit in one operating state could for example change such as for example increase and/or reduce a value of the coupling parameter. For example as an alternative or in addition thereto, the safety unit in one operation state in the case of the change to the coupling parameter could control and/or regulate at least one further unit, which in particular, as a function of the control and/or regulation could change the coupling parameter and/or advantageously the value of the coupling parameter. As a consequence, it is possible to prevent in particular in an efficient and/or simple and/or cost-effective manner the transmission of energy to the second induction unit, whereby it is possible to realize a high degree of efficiency.

The coupling parameter could comprise for example at least one capacitance and/or an arbitrary series connection and/or parallel connection to capacitances. For example as an alternative or in addition thereto, the coupling parameter could comprise for example at least one inductance and/or an arbitrary series connection and/or a parallel connection to inductances. It is preferred that the coupling parameter comprises at least one impedance and/or an arbitrary series connection and/or a parallel connection to impedances. As a consequence, the inductive transmission of energy to the second induction unit can be prevented in particular in a simple manner, whereby in particular it is possible to realize a simple and/or uncomplicated embodiment.

Furthermore, it is proposed that the safety element is designed as a switching element. The safety element has in particular at least one electronic switch and is designed in particular as an electronic switch. For example, the safety element could have in particular a semi-conductor switch and/or at least one electromagnet switch and/or said safety element could be designed as such. The safety element could for example have at least one transistor and/or at least one thyristor and/or at least one relay and/or at least one diode and/or said safety element could be designed as such. As a consequence, it is possible to realize an optimal compromise between a maximized degree of safety and a cost-effective embodiment, with which it is possible in a cost-effective and/or efficient manner to avoid in particular damage to the household appliance.

Moreover, it is proposed that the safety element and the second induction unit are arranged in particular in a common switching circuit, and are connected in particular electrically in series. As a consequence, it is possible to use a particularly simple electrical circuit so as to prevent the inductive transmission of energy to the second induction unit, whereby in particular it is possible to realize a low error rate and/or low costs.

For example, the safety element could have in particular precisely one and advantageously precisely the particular safety element that could be connected in particular either to the second induction unit in particular electrically in series or to the second induction unit in particular electrically parallel to one another.

In particular as an alternative or in addition thereto, the safety unit could have for example at least two safety elements, of which in particular at least one safety element could be connected to the second induction unit in particular electrically in series and at least one, in particular further, safety element could be connected to the second induction unit in particular electrically parallel to one another. It is preferably proposed that the safety element and the second induction unit are arranged in particular in a common switching circuit and are connected parallel to one another. As a consequence, it is possible to realize in particular, a high degree of flexibility.

For example, the safety unit in one operating state could arrange the safety element in a blocking state of the safety element and consequently in particular set a relatively large value of the coupling parameter of the coupling of the first induction unit and of the second induction unit and in particular prevent at least in intervals the inductive transmission of energy to the second induction unit. The safety unit could, for example as an alternative or in addition thereto, in one operating state arrange the safety element in an enabling state of the safety element and consequently in particular set in particular a relatively small value of the coupling parameter of the coupling of the first induction unit and of the second induction unit and in particular enable at least in intervals the inductive transmission of energy to the second induction unit.

In particular in the case of a series connection of the second induction unit and of the switching element, the enabling state of the safety element could be in particular a closed state of the safety element. The blocking state of the switching element could be in particular in the case of a series connection of the second induction unit and of the switching element for example an open state of the switching element.

In particular in the case of a parallel connection of the second induction unit and of the switching element, the enabling state of the switching element could be in particular an open state of the switching element. The blocking state of the switching element could be in particular in the case of a series connection of the second induction unit and of the switching element for example a closed state of the switching element.

Furthermore it is proposed that the safety unit has at least one safety control unit, in particular at least the safety control unit, which is provided so as to communicate in particular in a wireless manner with at least one household appliance control unit of the household appliance, in particular at least with the household appliance control unit of the household appliance. In particular, the safety control unit in one operating state communicates, in particular in wireless manner, with the household appliance control unit of the household appliance. As a consequence, it is possible to perform in particular an optimal exchange of information, whereby it is possible to realize in particular a high degree of user comfort and/or a high degree of information transparency.

In particular, as a function of the safety parameter that the safety unit determines from the communication with the household appliance control unit, the safety unit makes a decision regarding preventing the inductive transmission of energy to the second induction unit and/or regarding enabling the inductive transmission of energy to the second induction unit. It is preferred that the safety control unit is provided so as, as a function of the safety parameter that comprises at least an incorrect communication with the household appliance control unit, to prevent at least in intervals the transmission of energy to the second induction unit. In one operating state, the safety unit in particular as a function of the safety parameter that comprises at least one incorrect communication with the household appliance control unit prevents at least in intervals the transmission of energy to the second induction unit. In particular in the case in which the safety unit in one operating state successfully communicates with the household appliance control unit and in particular receives from the household appliance control unit feedback that is expected and/or is correct, the safety unit in one operating state enables at least in intervals the inductive transmission of energy to the second induction unit. In particular in the case in which the safety unit in one operating state successfully communicates with the household appliance control unit and in particular receives from the household appliance control unit feedback that is not expected and/or is incorrect, the safety unit in one operating state prevents at least in intervals the inductive transmission of energy to the second induction unit. As a consequence it is possible to involve in particular a particularly safe decision criterion so as to make a decision regarding the prevention of the inductive transmission of energy to the second induction unit, whereby it is possible to provide in particular an optimal safety standard.

In addition, it is proposed that the household unit has at least one energy consumer which is supplied at least in part with energy by the second induction unit in one operating state. The term an ‘energy consumer’ is to be understood to mean in particular a unit that in one operating state consumes energy, in particular electrical energy, and for example with the consumed energy performs at least one function. The energy consumer could have for example at least one electrical component and/or at least one electrical resistance and/or at least one heating unit and/or at least one electric motor and/or at least one processing tool. In particular as an alternative or in addition thereto, the energy consumer could have for example at least one electronic component and/or at least one control unit and/or at least one electronic unit. The phrase ‘that the second induction unit in one operating state supplies the energy consumer “at least in part” with energy’ is to be understood to mean that the second induction unit in one operating state supplies energy to the energy consumer alone or jointly with at least one further unit. The further unit with which the second induction unit in one operating state supplies the energy consumer jointly with energy could have for example at least one capacitance, such as for example at least one resonance capacitance, and/or at least one inductance. As a consequence, the inductively transmitted energy can be supplied directly at least for one purpose and/or so as to perform at least one function, whereby in particular it is possible to realize a particularly high degree of efficiency and/or a high degree of user comfort.

For example, the second induction unit in one operating state could transmit the energy in a wired manner to the energy consumer. It is preferred that the second induction unit is provided at least in part so as to transmit energy in a wireless manner to the energy consumer. In particular the second induction unit in one operating state transmits the energy at least in part in a wireless manner to the energy consumer. The second induction unit in one operating state supplies in particular the energy consumer at least inductively with energy. As a consequence, it is possible to realize in particular a particularly high degree of flexibility.

Moreover, it is proposed that the second induction unit is provided so as at least in part to transmit the energy in a wired manner to the energy consumer. In particular, the second induction unit in one operating state transmits the energy at least in part in a wired manner to the energy consumer. The second induction unit and the energy consumer are in particular arranged in a common switching circuit and are connected in particular electrically in series. As a consequence, it is possible to realize in particular a relatively low error rate and/or a low degree of susceptibility to failure during the transmission of energy to the energy consumer, whereby it is possible in particular to realize a high degree of satisfaction for the user.

The safety unit could be integrated for example at least in part and advantageously at least to a large extent in the household appliance. It is preferred that the safety unit is integrated at least to a large extent in the household unit and is integrated particularly advantageously in the household unit, whereby it is possible for example to realize a compact embodiment and/or to hold a relatively small amount of stock and/or to realize a relatively small variety of components. As a consequence, it is possible to avoid in particular a change of the household appliance and/or an influence on the production of the household appliance on account of the safety unit, whereby it is possible to realize in particular particularly low costs.

For example, the household unit could have at least one small household appliance and in particular could be designed as a small household appliance. The household unit is designed in particular as a small kitchen appliance. The household unit could be for example at least one toaster and/or at least one in particular fully automatic food processor and/or at least one juice extractor and/or at least one juicer and/or at least one kettle and/or at least one mixer and/or at least one coffee machine and/or at least one espresso machine and/or at least one cutting appliance and/or at least one spiral cutting appliance. It is preferred that the household unit has at least one item of cooking dishware and is advantageously designed as cooking dishware, whereby it is possible to avoid in particular an uncontrolled transmission of energy to the household unit that comprises the cooking dishware, as a result of which it is possible to avoid in particular overcooking and/or burning food and the associated damage to the cooking dishware and/or to the household appliance. In particular, it is possible hereby to realize a particularly high degree of user comfort and/or a high degree of safety for a user.

It is possible to realize a particular high degree of safety in particular by using at least one and advantageously using at least the household unit.

It is possible to realize an optimal safety standard by using a method for operating a household appliance system in accordance with the invention, in particular for operating an induction household appliance system, advantageously a cooking system, particularly advantageously an induction cooking system, preferably a hob-type cooking system and particularly preferably an induction hob-type cooking system, having at least one household appliance, which has at least a first induction unit that is provided so as to inductively supply energy, and having at least one household unit, which has at least a second induction unit that is provided so as to inductively receive the energy that is supplied, wherein as a function of at least one safety parameter a transmission of energy to the second induction unit is prevented at least in intervals.

The household appliance system is not to be limited to the above-described utilization and embodiment. In particular, so as to fulfill a function mode described herein, the household appliance system can have of a different number of individual elements, components and units to the number thereof mentioned herein.

Further advantages are apparent in the following description of the drawings. Exemplary embodiments of the invention are illustrated in the drawings. The drawings, the description and the claims comprise numerous features in combination. The person skilled in the art will also consider the features in a purposeful manner individually and combine said features in an expedient manner to form further combinations.

### IN THE DRAWINGS

FIG. 1 shows a household appliance system having a household appliance and having a household unit in a schematic plan view,

FIG. 2 shows a section along the line II-II from FIG. 1 in a schematic sectional view,

FIG. 3 shows a detail of an electrical switching circuit in which a coupling of the household appliance and of the household unit is illustrated, in a schematic view,

FIG. 4 shows a diagram of a method for operating the household appliance system, in a schematic view,

FIG. 5 shows a detail of an electrical switching circuit of an alternative household appliance system in which a coupling of a household appliance and of an alternative household unit of the household appliance system is illustrated, in a schematic view,

FIG. 6 shows a detail of an electrical switching circuit of an alternative household appliance system in which a coupling of a household appliance and of an alternative household unit of the household appliance system is illustrated, in a schematic view and

FIG. 7 shows a detail of an electrical switching circuit of an alternative household appliance system, in which a coupling of a household appliance and of an alternative household unit of the household appliance system is illustrated, in a schematic view.

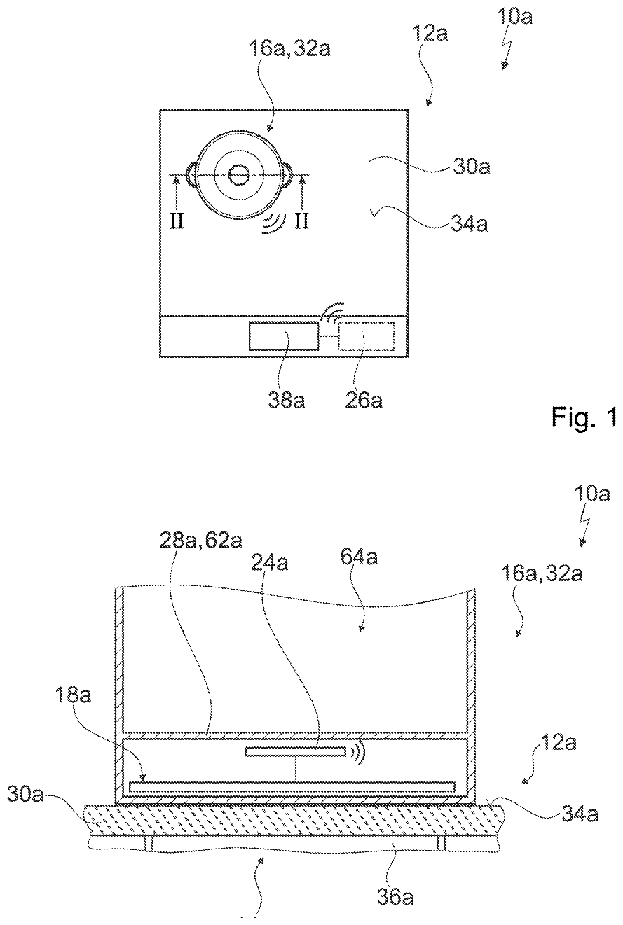

FIG. 1 illustrates by way of example a household appliance system 10a that is designed in particular as an induction household appliance system. The household appliance system 10a has in particular at least one and advantageously precisely one household appliance 12a.

For example, the household appliance system 10a could be designed as a cleaning appliance system and/or as a refrigeration appliance system. In particular, the household appliance 12a could be designed as a cleaning appliance, such as for example as a dryer and/or as a washing machine and/or as a dishwasher.

Advantageously, the household appliance system 10a is designed as a cooking appliance system and particularly advantageously as an induction cooking appliance system. The household appliance 12a could be designed for example as an oven and/or as a microwave and/or as a grill appliance and/or as a steam cooking appliance. The oven could be for example a cooker and/or or a baking oven.

In the present exemplary embodiment, the household appliance system 10a is advantageously designed as a hob-type cooking system and particularly advantageously as an induction hob-type cooking system. Advantageously, the household appliance 12a is designed as a hob and particularly advantageously as an induction hob.

The household appliance 12a has in particular at least one and advantageously precisely one appliance plate 30a. In particular, the appliance plate 30a in one operating state forms at least one part at least of one appliance housing of the household appliance 12a. The appliance plate 30a in one operating state forms in particular at least one visible side and/or visible surface which faces in particular at least one user. In one operating state, the appliance plate 30a is arranged in particular facing the user.

In the present exemplary embodiment, the appliance plate 30a is designed in particular as a placement plate. For example, the appliance plate 30a could be designed as a hob plate and/or as a work plate, in particular as a kitchen worktop. The appliance plate 30a is in particular provided for placement of the cooking dishware 32a, in particular for the purpose of heating the cooking dishware 32a.

The appliance plate 30a defines in particular at least one and advantageously precisely one cooking surface 34a. The cooking surface 34a is designed in particular as a surface of the appliance plate 30a which faces a user and below which in at least one operating state in particular at least one heating unit 36a is arranged (cf. FIG. 2). Of the multiple objects present, only one of them is provided in particular in each case with a reference character in the figures.

The cooking dishware 32a is in the present exemplary embodiment in particular part at least of one household unit 16a, in particular of the household appliance system 10a (cf. FIGS. 1 and 2). The household appliance system 10a has in particular at least one and advantageously at least the household unit 16a. For example, the household appliance system 10a could have at least two, advantageously at least three, particularly advantageously at least four, preferably at least five and particularly preferably multiple household units 16a.

At least one of the household units 16a could have in particular at least one and advantageously at least the cooking dishware 32a. For example, at least one of the household units 16a could be designed as cooking dishware 32a. At least one of the household units 16a could have, for example as an alternative or in addition thereto, in particular at least one household appliance and advantageously at least one small household appliance and/or could be designed as a household appliance and advantageously as a small household appliance. By way of example, only one of the household units 16a is described below, and in fact by way of example a household unit 16a that has the cooking dishware 32a.

The household appliance 16a is designed and/or provided and/or suitable in particular especially for the household appliance system 10a. In the present exemplary embodiment, the household unit 16a is designed in particular as at least one accessory for the household appliance 12a and/or as at least one set of accessories for the household appliance 12a.

The household unit 16a is provided in particular for placement of the appliance plate 30a, in particular on the cooking surface 34a of the appliance plate 30a, in particular for the purpose of heating the household unit 16a and/or for the purpose of an inductive transmission of energy to the household appliance 16a. In the present exemplary embodiment, the household unit 16a is provided in particular for a flexible placement on the cooking surface 34a, in particular for the purpose of heating the household unit 16a and/or for the purpose of an inductive transmission of energy to the household unit 16a. In particular, the household unit 16a is provided for a placement on at least one, in particular arbitrary placement position on the cooking surface 34a.

The household appliance 12a has in particular at least one and advantageously precisely one user interface 38a (cf. FIG. 1). The user interface 38a is provided in particular so as to input and/or select operating parameters, such as for example at least one heating power and/or at least one heating power density and/or at least one heating zone and/or at least one temperature and/or at least one cooking parameter at least of one appliance function. The user interface 38a is provided in particular so as to output, for example a value at least of one operating parameter and/or of at least one piece of information and/or at least one operating request, in particular to a user.

The household appliance 12a has in particular at least one and advantageously precisely one household appliance control unit 26a. In the operating state, the household appliance control unit 26a controls and/or regulates in particular at least one household appliance function and advantageously at least one household appliance main function. The household appliance control unit 26a is provided in particular so as, as a function of the operating parameters that are input by means of the user interface 38a to perform actions and/or to change settings. The household appliance control unit 26a in one operating state controls and/or regulates in particular an energy supply to at least one first induction unit 14a of the household appliance 12a and/or to the heating unit 36 of the first induction unit 14a.

The household appliance 12a has in particular at least one and advantageously at least the first induction unit 14a. The first induction unit 14a has in particular at least one and advantageously at least the heating unit 36a. In the present exemplary embodiment, the first induction unit 14a has in particular at least two, advantageously at least four, particularly advantageously at least eight, preferably at least twelve and particularly preferably a multiplicity of heating units 36a. The heating units 36a could be arranged for example in the form of a matrix.

The first induction unit 14a defines in particular the cooking surface 34a and in fact in particular by an arrangement of the heating units 36a of the first induction unit 14a. Only one of the heating units 36a is described below.

The heating unit 36a is arranged in an installed position in particular below the appliance plate 30a. The heating unit 36a is provided in particular so as to heat the household unit 16a that has in particular the cooking dishware 32a and is advantageously placed on the appliance plate 30a above the heating unit 36a and/or to supply inductive energy to the household unit 16a. The household unit 36a is designed in particular as an induction heating unit. In the operating state, the household unit 36a is arranged in particular below the cooking surface 34a.

In one operating state, the first induction unit 14a inductively supplies energy, in particular by means of the heating unit 36a, in particular to the household unit 16a. The first induction unit 14a supplies the energy in particular for the purpose of heating the household unit 16a that has the cooking dishware 32a and/or for the purpose of an inductive transmission of energy to the household unit 16a. In particular, the first induction unit 14a is provided so as to inductively supply energy, in particular to the household unit 16a.

In one operating state, the household appliance control unit 26a controls and/or regulates in particular the first induction unit 14a. The household appliance control unit 26a in one operating state inductively supplies in particular by means of the first induction unit 14a energy to the household unit 16a, in particular for the purpose of heating the household unit 16a that has the cooking dishware 32a and/or for the purpose of an inductive transmission of energy to the household unit 16a.

The household unit 16a is provided in particular so as to inductively receive energy that is supplied inductively and goes beyond purely inductively heating the household unit 16a that has the cooking dishware 32a.

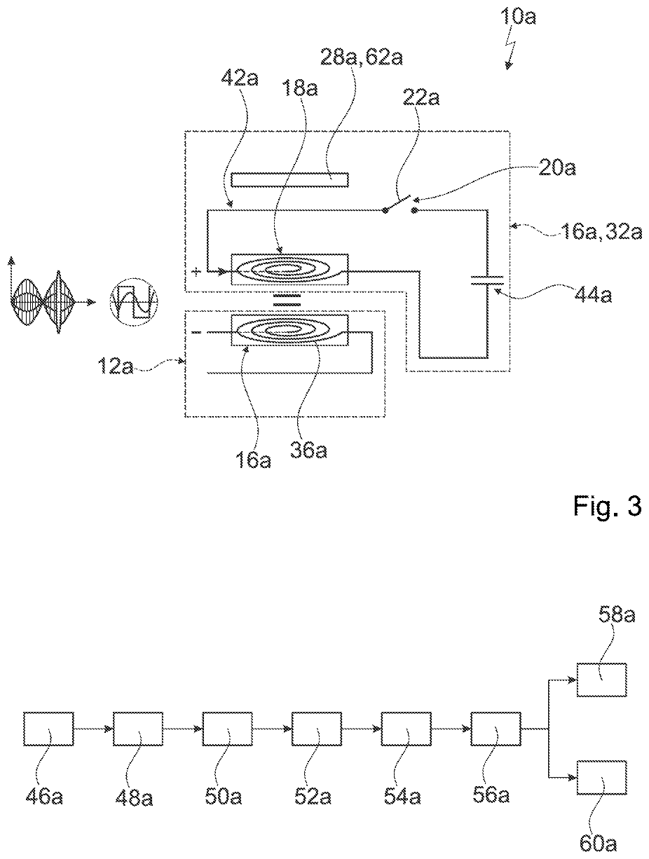

In particular so as to inductively receive energy, the household unit 16a has in particular at least one second induction unit 18a (cf. FIGS. 2 and 3). In the present exemplary embodiment, the household unit 16a has in particular precisely the second induction unit 18a. The second induction unit 18a is provided in particular so as to inductively receive the energy that is supplied. In one operating state, the second induction unit 18a inductively receives, in particular the energy that is supplied in particular by the first induction unit 14a.

The household appliance system 10a has in particular at least one and advantageously precisely one safety unit 20a. In particular, the safety unit 20a is provided so as, as a function of at least one safety parameter to prevent at least in intervals a transmission of energy to the second induction unit 18a. In one operating state, the safety unit 20a as a function of the safety parameter prevents at least in intervals the transmission of energy to the second induction unit 18a.

The safety unit 20a has advantageously at least one safety element 22a. For example, the safety unit 20a could have in particular in addition to the safety element 22a, at least one and advantageously precisely one further safety element (not illustrated in the present exemplary embodiment). In the present exemplary embodiment, the safety unit 20a has in particular precisely the safety element 22a.

In particular, the safety unit 20a is provided so as by means of the safety element 22a to change at least one coupling parameter of a coupling of the first induction unit 14a and of the second induction unit 18a so as to prevent the transmission of energy. In one operating state, the safety unit 20a changes, in particular by means of the safety element 22a, the coupling parameter of the coupling of the first induction unit 14a and of the second induction unit 18a so as to prevent the transmission of energy. So as to change the coupling parameter of the coupling of the first induction unit 14a and of the second induction unit 18a, the safety unit 20a in one operating state changes a position of the safety element 22a.

The safety element 22a is advantageously designed as a switching element. In the present exemplary embodiment, the safety element 22a is designed in particular as a relay and by way of example as an electromagnetic relay.

In one operating state, the safety unit 20a changes in particular by changing a position of the safety element 22a a value of the coupling parameter of the coupling of the first induction unit 14a and of the second induction unit 18a. For example, the safety unit 20a in one operating state could arrange the safety element 22a in a blocking state of the safety element 22a and consequently in particular set a relatively large value of the coupling parameter of the coupling of the first induction unit 14a and of the second induction unit 18a and in particular prevent at least in intervals the inductive transmission of energy to the second induction unit 18a.

For example as an alternative or in addition thereto, the safety unit 20a in one operating state could arrange the safety element 22a in an enabling state of the safety element 22a and consequently in particular set a relatively small value of the coupling parameter of the coupling of the first induction unit 14a and of the second induction unit 18a and in particular enable at least in intervals the inductive transmission of energy to the second induction unit 18a.

In the present exemplary embodiment, the enabling state of the safety element 22a is in particular a closed state of the safety element 22a. In particular, the blocking state of the safety element 22a is an open state of the safety element 22a.

In the present exemplary embodiment, the coupling parameter is in particular an electrical and/or electronic parameter and/or an electrical and/or electronic signal. The coupling parameter comprises in particular at least one impedance. In particular, the coupling parameter comprises in particular an impedance of an electrical coupling between the first induction unit 14a and the second induction unit 18a.

The safety element 22a and the second induction unit 18a are particularly advantageously arranged in a common, in particular electrical, switching circuit 42a (cf. FIG. 3). In particular, the safety element 22a and the second induction unit 18a are electrically connected to one another. In the present exemplary embodiment, the safety element 22a and the second induction unit 18a are connected in particular electrically in series.

The safety unit 20a has in particular at least one and advantageously precisely one safety control unit 24a (cf. FIG. 2). The safety control unit 24a is in particular provided so as to communicate, in particular in a wireless manner with the household appliance control unit 26a of the household appliance 12a. In one operating state, the safety control unit 24a and the household appliance control unit 26a communicate with one another in particular in a wireless manner.

The safety control unit 24a is provided in particular so as, as a function of the safety parameter, which comprises at least one incorrect communication with the household appliance control unit 26a, to prevent at least in intervals the transmission of energy to the second induction unit 18a. In one operating state, the safety unit 20a determines, in particular by means of the safety control unit 24a of the safety unit 20a, the safety parameter from the communication of the household appliance control unit 26a. In particular, the safety unit 20a in one operating state, in particular by means of the safety control unit 24a, as a function of the safety parameter prevents at least in intervals the transmission of energy to the second induction unit 18a.

The safety parameter comprises in particular a result of a communication of the safety control unit 24a with the household appliance control unit 26a. In particular, the safety parameter comprises at least one incorrect communication with the household appliance control unit 26a, as a function of which the safety unit 20a in particular by means of the safety control unit 24a prevents at least in intervals the inductive transmission of energy.

In particular in the case in which the safety unit 20a in one operating state successfully communicates in particular by means of the safety control unit 24a with the household appliance control unit 26a, the safety unit 20a in one operating state enables at least in intervals the inductive transmission of energy to the second induction unit 18a. In particular in the case in which the safety unit 20a, in particular by means of the safety control unit 24a, in one operating state unsuccessfully communicates with the household appliance control unit 26a, the safety unit 20a in one operating state prevents at least in intervals the inductive transmission of energy to the second induction unit 18a.

In the present exemplary embodiment, the safety unit 20a is in particular at least in part and advantageously at least to a large extent integrated in the household unit 16a. In particular, the safety unit 20a is part of the household unit 16a. The household unit 16a has in particular the safety unit 20.

The household unit 16a has in particular at least one and advantageously precisely one energy consumer 28a. In one operating state, the second induction unit 18a supplies the energy consumer 28a at least in part with energy. In particular, the second induction unit 18a is provided so as at least in part to supply energy to the energy consumer 28a.

For example, the energy consumer 28a could have at least one electrical resistance and/or could be designed as an electrical resistance. The energy consumer 28a could for example be designed as a bottom wall 62a of the household unit 16a that has the cooking dishware 32a. The bottom wall 62a could delimit in particular in the downward direction at least in part and advantageously in one operating state for example at least one food receiving compartment 64a of the household unit 16a that has the cooking dishware 32a. In particular, the energy consumer 28a could consume the supplied energy so as to heat at least one item of food that could be arranged in the household unit 16a that has the cooking dishware 32a.

In one operating state, the second induction unit 18a supplies in particular the energy consumer 28a at least in part with energy which the second induction unit 18a receives in particular from the first induction unit 14a. In particular, the second induction unit 18a in one operating state supplies the energy consumer 28a with energy at least in part in a wireless manner. In the present exemplary embodiment, the second induction unit 18a in particular in one operating state supplies the energy consumer 28a at least in part inductively with energy.

In one operating state, the second induction unit 18a supplies in particular the energy consumer 28a with energy jointly with at least one further unit 44a. The household unit 16a has in particular at least one and advantageously at least the further unit 44a. The further unit 44a, with which the second induction unit 18a in one operating state supplies the energy consumer 28a jointly with energy, could have for example at least one capacitance, such as for example at least one resonance capacitance and/or said further unit could be designed as such.

In particular, the further unit 44a and the second induction unit 18a are arranged in the common switching circuit 42a. The further unit 44a and the second induction unit 18a are connected in particular electrically in series. Advantageously, the further unit 44a and the second induction unit 18a are part at least of one oscillating circuit and in one operating state transmit in particular by means of the resonant circuit the energy, in particular in a wireless manner, to the energy consumer 28a.

In one method for operating the household appliance system 10a, in particular in an energy supplying step 46a, in particular energy is inductively supplied in particular by the first induction unit 14a (cf. FIG. 4). In particular in at least one energy receiving step 48a, in particular the energy that is inductively supplied in particular by the first induction unit 14a is received by the second induction unit 18a. FIG. 4 illustrates the energy supplying step 46a and the energy receiving step 48a in particular chronologically one after the other.

Advantageously, the energy supplying step 46a and the energy receiving step 48a are performed in particular at least in intervals and particularly advantageously at least to a large extent simultaneously.

In particular in at least one communicating step 50a, communication takes place in particular in a wireless manner in particular advantageously between the safety control unit 24a and the household appliance control unit 26a. In particular in at least one evaluating step 52a, in particular the communication, in particular between the safety control unit 24a and the household appliance control unit 26a, is advantageously evaluated by the safety unit 20a.

In one operating state, in particular in at least one determining step 54a, the safety parameter is determined as a function of a result of the communication in particular between the safety control unit 24a and the household appliance control unit 26a, advantageously by the safety unit 20a. In particular in at least one decision making step 56a, a decision is made in particular by the safety unit 20a as a function of the safety parameter as to whether the inductive transmission of energy to the second induction unit 18a is to be enabled at least in intervals and/or is to be prevented at least in intervals.

In particular in at least one enabling step 58a, the transmission of energy to the second induction unit 18a is enabled at least in intervals, in particular by the safety unit 20a, in particular as a function of the safety parameter and advantageously as a function of a result of the decision.

In particular in at least one preventing step 60a, the transmission of energy to the second induction unit 18a is prevented at least in intervals, in particular by the safety unit 20a, in particular as a function of the safety parameter and advantageously as a function of a result of the decision.

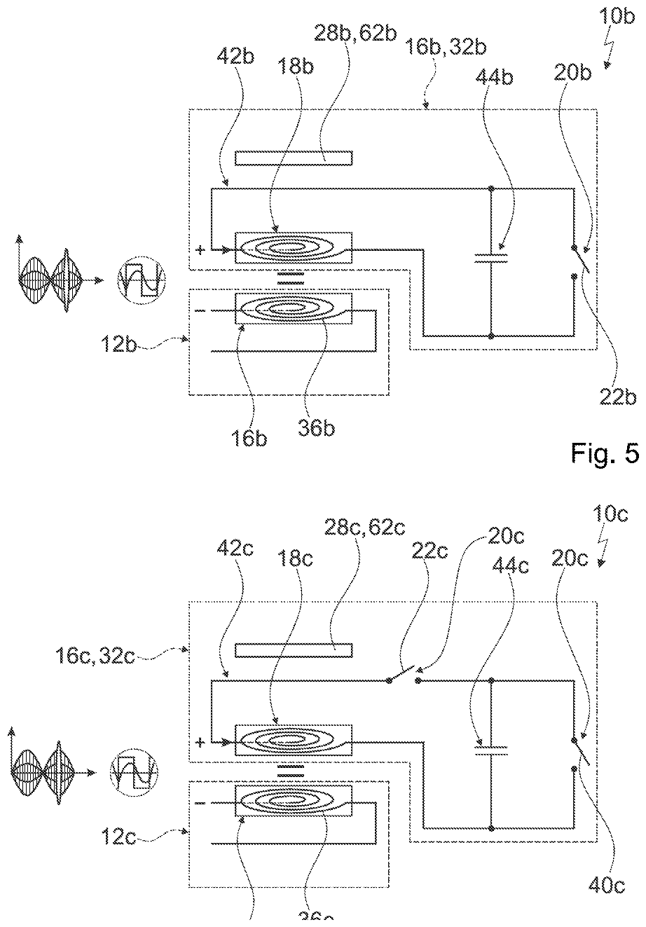

FIGS. 5 to 7 illustrate three further exemplary embodiments of the invention. The descriptions below are limited essentially to the differences between the exemplary embodiments, wherein with regard to consistently identical components, features and functions reference can be made to the description of the exemplary embodiment that is illustrated in FIGS. 1 to 4. In order to differentiate between the exemplary embodiments, the letter a in the reference characters of the exemplary embodiment that is illustrated in FIGS. 1 to 4 has been replaced by the letters b to d in the reference characters of the exemplary embodiment that is illustrated in FIGS. 5 to 7. With regard to components with the same designation, in particular with regard to components having identical reference characters, reference can also be fundamentally made to the drawings and/or the description of the exemplary embodiments illustrated in FIGS. 1 to 4.

FIG. 5 illustrates by way of example a detail of an electrical switching circuit 42b of an alternative household appliance system 10b. The household appliance system 10b has in particular a household unit 16b, which has in particular a second induction unit 18b, and in particular a safety unit 20b, which has in particular a safety element 22b. The household appliance system 10b that is illustrated in FIG. 5 differs from the household appliance system 10a that is described by FIGS. 1 to 4 relative to the second induction unit 18b by way of example by an in particular electrical arrangement of the safety element 22b.

In particular, the second induction unit 18b and the safety element 22b are arranged in the common, in particular electrical, switching circuit 42b. In the present exemplary embodiment, the safety element 22b and the second induction unit 18b are connected in particular parallel to one another.

FIG. 6 illustrates by way of example a detail of an electrical switching circuit 42c of an alternative household appliance system 10c. The household appliance system 10c has in particular a household unit 16c, which has in particular a second induction unit 18c, and in particular a safety unit 20c. The household appliance system 10c that is illustrated in FIG. 6 is by way of example designed as a combination of the household appliance system 10a that is described by FIGS. 1 to 4 and of the household appliance system 10b that is described by the FIG. 5. In particular, the safety unit 20c is designed as a combination of the respective safety units 20a, 20b.

In particular, the safety unit 20c in the present exemplary embodiment has at least one and advantageously precisely one safety element 22c. In particular, the safety element 22c and the second induction unit 18c are connected in particular electrically in series.

The safety unit 20c has, in particular in addition to the safety element 22c, in particular at least one and advantageously precisely one further safety unit 40c. The further safety element 40c is designed in particular as a switching element, such as for example an, in particular magnetic, relay. In particular, the further safety element 40c and the second induction unit 18c are connected in particular electrically parallel to one another.

The combination of the safety element 22c and the further safety element 40c renders it possible to realize in particular a particularly high safety standard since for example in the event that the safety element 22c, 40c remains in an enabling state of the corresponding safety element 22c 40c, it is nonetheless still possible to guarantee inductive transmission of energy to the second induction unit 18c being prevented at least in intervals, and in fact in particular by arranging the remaining safety elements 22c, 40c in a blocking state of the corresponding safety element 22c, 40c.

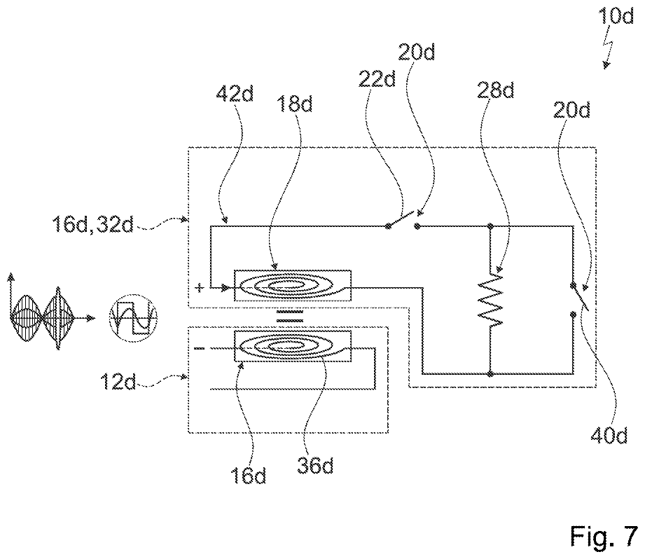

FIG. 7 illustrates by way of example a detail of an electrical switching circuit 42d of an alternative household appliance system 10d. The household appliance system 10d has in particular a household unit 16d, which has in particular a second induction unit 18d, and in particular a safety unit 20d. The household appliance system 10d that is illustrated in FIG. 7 differs by way of example from a household appliance system 10c that is described by FIG. 6 by a design of the household unit 16d and in fact in particular by a design of an energy consumer 28d of the household unit 16d and in particular an electrical connection of the energy consumer 28d in the switching circuit 42d.

The household unit 16d has in particular the energy consumer 28d. The energy consumer 28d is designed in the present exemplary embodiment in particular as an electrical resistance. In particular, the energy consumer 28d is connected in the common electrical switching circuit 42d and in fact jointly with the second induction unit 18d and safety elements 22d, 40d of the safety unit 20d. The energy consumer 28d is connected in particular electrically in series to the second induction unit 18d.

In one operating state, the second induction unit 18d supplies in particular the energy consumer 28d at least in part with energy. In particular, the second induction unit 18d transmits the energy in one operating state in a wired manner to the energy consumer 28d. The second induction unit 18d is provided in particular at least in part so as to transmit the energy in a wired manner to the energy consumer 28d.

The household unit 16d is designed in the present exemplary embodiment in particular as a small electrical appliance and/or advantageously as a small household appliance and/or particularly advantageously as a small kitchen appliance.

For example as an alternative to the safety unit 20d that is illustrated in FIG. 7, the safety unit 20d could have precisely one safety element 22d, in particular in the case of a household unit 16d that is designed as a small electrical appliance and/or as a small household appliance and/or particularly advantageously as a small kitchen appliance. For example, the safety element 22d and the second induction unit 18d could be connected in particular electrically in series, and/or in particular electrically parallel to one another, such as has been described and/or illustrated for example in the household appliance system 10a of FIGS. 1 to 4 and/or in the household appliance system 10b of FIG. 5.

### REFERENCE CHARACTERS

10 Household appliance system
12 Household appliance
14 First induction unit
16 Household unit
18 Second induction unit
20 Safety unit
22 Safety element
24 Safety control unit
26 Household appliance control unit
28 Energy consumer
30 Appliance plate
32 Cooking dishware
34 Hob-type surface
36 Heating unit
38 User interface
40 Further safety element
42 Switching circuit
44 Further unit
46 Energy supplying step
48 Energy receiving step
50 Communicating step
52 Evaluating step
54 Determining step
56 Decision-making step
58 Enabling step
60 Preventing step
62 Bottom wall
64 Food receiving compartment

1-15. (canceled)

16. A household appliance system, comprising:
a household appliance including a first induction unit configured to inductively supply energy;
a household unit including a second induction unit configured to inductively receive the energy that is supplied from the first induction unit; and
a safety unit configured to prevent, as a function of a safety parameter, at least in an interval a transmission of energy to the second induction unit.

17. The household appliance system of claim 16, constructed in the form of a hob-type cooking system.

18. The household appliance system of claim 16, wherein the safety unit includes a safety element to change a coupling parameter of a coupling of the first induction unit and of the second induction unit so as to prevent the transmission of energy to the second induction unit.

19. The household appliance system of claim 18, wherein the coupling parameter comprises an impedance.

20. The household appliance system of claim 18, wherein the safety element is designed as a switching element.

21. The household appliance system of claim 18, wherein the safety element and the second induction unit are connected in series.

22. The household appliance system of claim 18, wherein the safety element and the second induction unit are connected parallel to one another.

23. The household appliance system of claim 16, wherein the safety unit includes a safety control unit configured to communicate with a household appliance control unit of the household appliance.

24. The household appliance system of claim 23, wherein the safety control unit is configured to prevent, as a function of the safety parameter, which comprises an incorrect communication with the household appliance control unit, at least in an interval the transmission of energy to the second induction unit.

25. The household appliance system of claim 16, wherein the household unit includes an energy consumer, said second induction unit supplying the energy consumer in one operating state at least in part with energy.

26. The household appliance system of claim 25, wherein the second induction unit is configured to transmit at least in part the energy in a wireless manner to the energy consumer.

27. The household appliance system of claim 25, wherein the second induction unit is configured to transmit at least in part the energy in a wired manner to the energy consumer.

28. The household appliance system of claim 16, wherein the safety unit is integrated at least to a large extent in the household unit.

29. The household appliance system of claim 16, wherein the household unit includes an item of cooking dishware.

30. A household unit of a household appliance system, said household unit comprising:
an item of cooking dishware; and
an induction unit configured to inductively receive energy supplied from an induction unit of a household appliance of the household appliance system to heat the item of cooking dishware as a function of a safety parameter to prevent, at least in an interval a transmission of energy to the induction unit of the household unit.

31. The household unit of claim 30, further comprising an energy consumer, said induction unit of the household unit supplying the energy consumer in one operating state at least in part with energy.

32. The household unit of claim 31, wherein the induction unit of the household unit is configured to transmit at least in part the energy in a wireless manner to the energy consumer.

33. The household unit of claim 31, wherein the induction unit of the household unit is configured to transmit at least in part the energy in a wired manner to the energy consumer.

34. A method of operating a household appliance system, comprising:
inductively transmitting energy by a first induction unit of a household appliance of the household appliance system to a second induction unit of a household unit of the household appliance system; and
preventing at least in an interval a transmission of energy to the second induction unit as a function of a safety parameter.

35. The method of claim 34, further comprising changing an impedance of a coupling of the first induction unit and of the second induction unit to prevent the transmission of energy to the second induction unit.

36. The method of claim 34, wherein the transmission of energy to the second induction unit is prevented when a communication of a safety control unit of the household appliance system with a household appliance control unit of the household appliance is incorrect.

37. The method of claim 34, further comprising supplying the energy in one operating state at least in part to an energy consumer of the household unit in a wireless manner or a wired manner.
